(19) United States
(12) Patent Application Publication
(10) Pub. No.: US 2026/0195679 A1
(43) Pub. Date: Jul. 9, 2026

(54) Reusable Triggers for Workflows

(71) Applicant: ServiceNow, Inc., Santa Clara, CA (US)

(72) Inventors: Jacob Burman, Carlsbad, CA (US); Radha Krishna Singireddy, Hyderabad (IN); Harry Thomas Nelson, San Diego, CA (US); Srinivas Kothuri, Hyderabad (IN); Sasikanth Marella, Hyderabad (IN); Riya Kapoor, Hyderabad (IN)

(21) Appl. No.: 19/015,152

(22) Filed: Jan. 9, 2025

(51) Int. Cl. G06Q 10/0631; G06F 9/451

(52) U.S. Cl. CPC G06Q 10/06316; G06F 9/451

(57) ABSTRACT

A method includes receiving a reusable definition of a flow trigger, and storing the reusable definition of the flow trigger in persistent storage. The method also includes receiving a request to integrate the flow trigger into an instruction flow and, based on receiving the request, retrieving the reusable definition of the flow trigger from persistent storage and providing the reusable definition of the flow trigger for integration into the instruction flow.

### BACKGROUND

Computing platforms can be used to facilitate workflows - automated or semi-automated multi-step processes that occur between any combination of computing elements, applications, and/or individuals. These workflows can be complex, involving numerous states and transitions therebetween that may be followed based on conditional processing. As the relevance of workflows grows, it becomes increasingly important to make the process of defining, modifying, and deploying the workflows easier and/or more efficient. Improperly defined or erroneous workflows can waste computing resources (e.g., processing, memory, network, and/or power capacity) by introducing errors into systems and causing computationally-expensive corrective procedures to be performed.

### SUMMARY

A software application may be used to define, store, and/or execute various aspects of different workflows. Specifically, the software application may allow a user to define, store, and/or use a reusable definition of a flow trigger. The flow trigger may represent one or more conditions that, when met, cause execution of one or more instructions of a workflow containing the flow trigger. For example, the flow trigger may be used to start the workflow and/or to cause the workflow to continue executing. The reusable definition of the flow trigger may be flow-independent, and may thus be able to be integrated with some, most, or all workflows (e.g., regardless of the function(s) and/or operation(s) performed thereby) without any modification to the definition, and may thus allow low-code and/or no-code users to easily use the flow trigger in various workflows. For example, the reusable definition of the flow trigger may be added to a given workflow using a graphical user interface without reconfiguring the reusable definition of the flow trigger and/or writing any source code.

Using the reusable definition of the flow trigger may allow users to avoid manually duplicating the same or similar trigger logic across multiple workflows. Namely, rather than manually recreating a given flow trigger for each of the multiple workflows, the trigger logic may be specified once while defining the flow trigger using the software application, and the trigger logic may be saved as part of the reusable definition of the flow trigger. Once saved, the reusable definition of the flow trigger may be added to each of the multiple workflows.

The reusable definition of the flow trigger may reduce the amount of storage (in the form of volatile and/or non-volatile memory) used by workflows, since fewer copies of the flow trigger may be stored across the multiple workflows (e.g., the multiple workflows may each reference one reusable definition). The reusable definition of the flow trigger may also reduce the amount of processor time it takes to define a new workflow and/or may reduce the likelihood of the workflow including software defects, since the flow trigger definition is reused rather than redefined anew for each workflow. Further, the reusable definition of the flow trigger may allow users to use the flow trigger in various workflows without needing to fully understand the implementations details of the flow trigger, thus allowing the flow trigger to be used by users (e.g., no-code and/or low-code users) that might otherwise be unable to manually define the flow trigger.

Accordingly, a first example embodiment may involve receiving a reusable definition of a flow trigger. The first example embodiment may also involve storing the reusable definition of the flow trigger in persistent storage. The first example embodiment may additionally involve receiving a request to integrate the flow trigger into an instruction flow. The first example embodiment may further involve, based on receiving the request, retrieving the reusable definition of the flow trigger from persistent storage and providing the reusable definition of the flow trigger for integration into the instruction flow.

A second example embodiment may involve a non-transitory computer-readable medium, having stored thereon program instructions that, upon execution by a computing system, cause the computing system to perform operations in accordance with any of the previous example embodiments.

In a third example embodiment, a computing system may include at least one processor, as well as memory and program instructions. The program instructions may be stored in the memory, and upon execution by the at least one processor, cause the computing system to perform operations in accordance with any of the previous example embodiments.

In a fourth example embodiment, a system may include various means for carrying out each of the operations of any of the previous example embodiments.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIG. 6 depicts a workflow system, in accordance with example embodiments.

FIGS. 7A, 7B, 7C, 7D, and 7E depict graphical user interfaces provided by a workflow system, in accordance with example embodiments.

FIGS. 8A, 8B, and 8C are message flow diagrams, in accordance with example embodiments.

FIG. 9 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of software features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. Example Technical Improvements

These embodiments provide a technical solution to a technical problem. One technical problem being solved is how to reduce the number of software errors introduced when defining instruction flows. In practice, this is problematic because executing, identifying, and resolving software errors consumes computing resources and/or software development time. Another technical problem being solved is how to reduce the amount of computing resources used in defining duplicative aspects of instruction flows.

In other techniques, instruction flows are manually defined by various users with varying degrees of programming skills, including low-code users and/or no-code users, some of whom may be more likely than others to introduce software errors. However, these techniques do not prevent users from introducing software errors into instruction flows, and utilize significant computing resources when defining duplicative (although non-reusable) portions of the instruction flows. Moreover, other approaches rely on subjective decisions and experiences of individual users, which leads to wildly varying outcomes from instance to instance. Thus, other techniques did little if anything to address the need for consistency, scalability, and efficiency in the reducing, elimination, and/or avoidance of software errors in instruction flows.

The embodiments herein overcome these limitations by providing reusable definitions of flow triggers, each of which may be defined and tested once and used as part of multiple different instruction flows. In this manner, a reduction in software errors, consistency in flow trigger performance, and reduced computational resource usage can be accomplished in a more accurate and robust fashion. This results in several advantages. First, any given flow trigger need not be redefined multiple times, and thus computing resources are not expended on performing largely duplicative tasks. Second, once a reusable definition is tested for software errors, an error free implementation of the flow trigger may be available to all users of a computing platform. Third, low-code and/or no-code users may gain access to flow trigger logic that might otherwise be prohibitively difficult to implement for such users.

Other technical improvements may also flow from these embodiments, and other technical problems may be solved. Thus, this statement of technical improvements is not limiting and instead constitutes examples of advantages that can be realized from the embodiments.

### II. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or eXtensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. Example Computing Devices and Cloud-Based Computing Environments

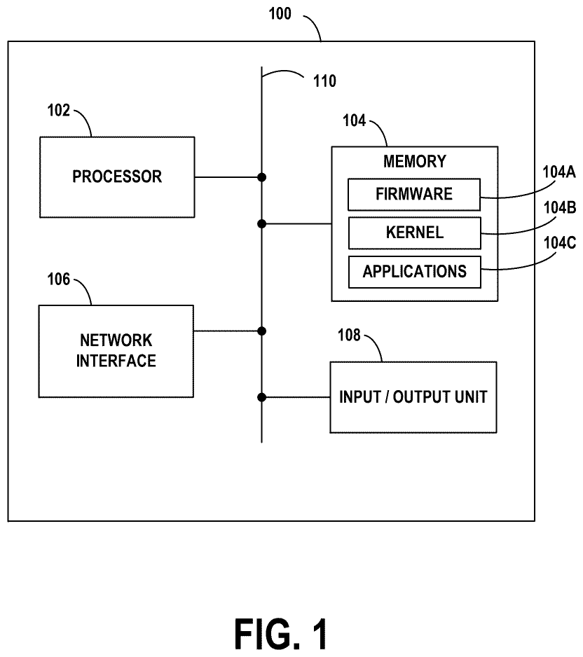

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), a digital signal processor (DSP), a network processor, an encryption processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently used instructions and data.

GPUs, in particular, have grown in importance. They include specialized circuitry designed to perform rapid mathematical calculations for rendering graphics, processing large datasets, and supporting machine learning. A GPU typically consists of hundreds or thousands of small cores that operate simultaneously, facilitating the decomposition of tasks into smaller, more manageable pieces that are processed in parallel. This parallelism allows GPUs to be significantly faster than traditional CPUs for certain types of calculations.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Herein, any non-volatile memory may be referred to as persistent storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Synchronous Digital Hierarchy (SDH), Data Over Cable Service Interface Specification (DOCSIS), or other technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

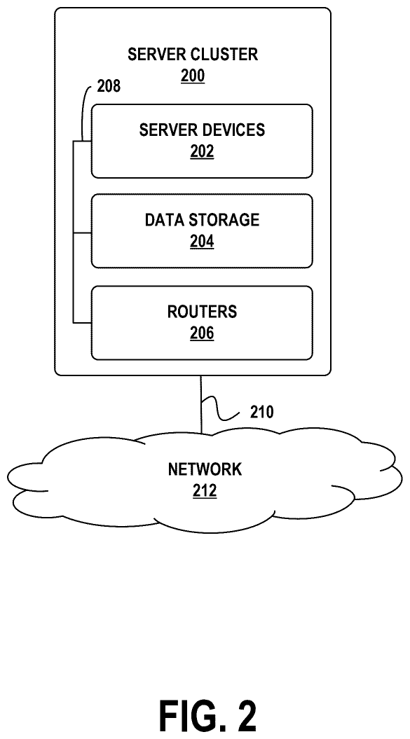

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. Example Remote Network Management Architecture

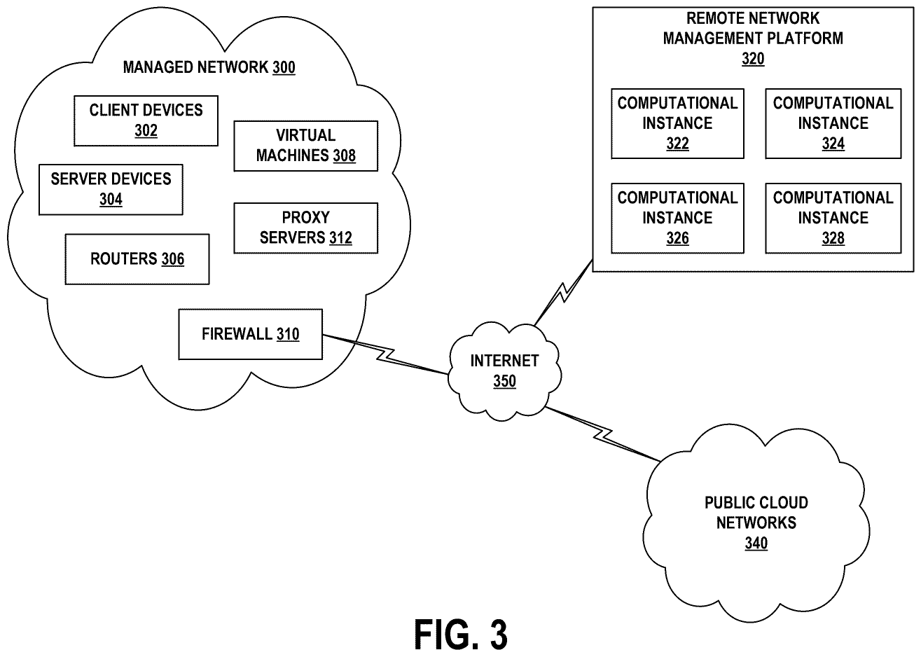

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers'data are separate from one another, the separation is enforced by the software that operates the single database. As a consequence, a security breach in this system may affect all customers'data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

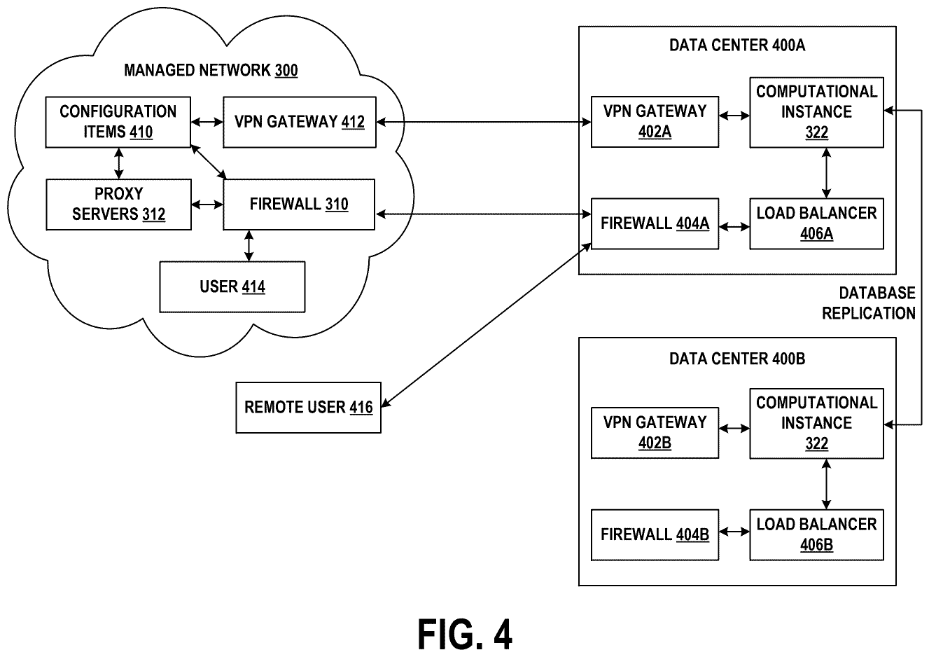

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. Example Discovery

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

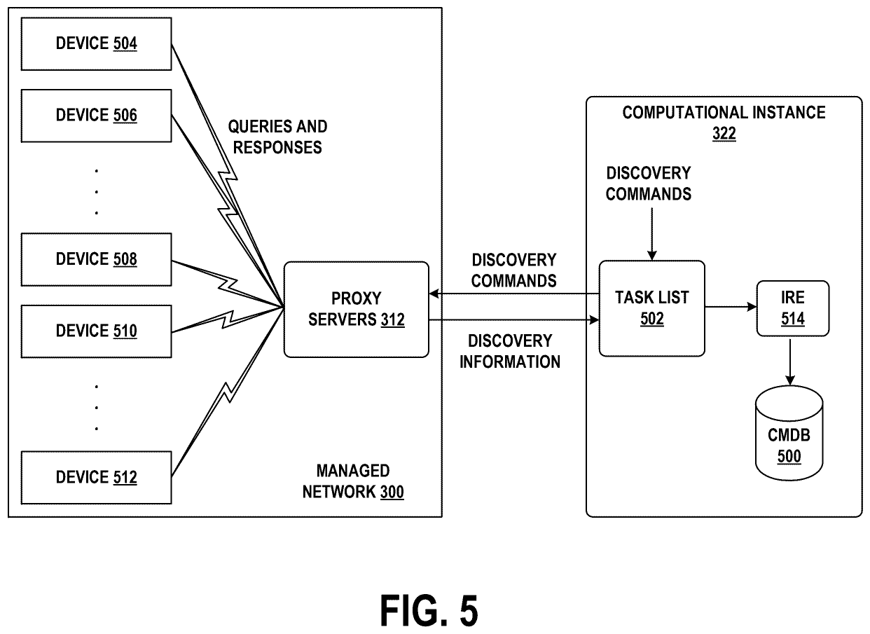

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery—horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases - under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB Identification Rules and Reconciliation

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. Example Platform Applications

As noted, remote network management platform 320 may support a number of applications and services, each of which may use or involve information from CMDB 500 and/or other databases as needed. Some of these applications and services may include task-based applications, workflows, user interface building tools, and agent interfaces, just to name a few. Other applications and services not explicitly discussed herein may benefit from the disclosed embodiments. Nonetheless, these task-based applications, workflows, user interface building tools, and agent interfaces (each of which may include one or more instruction flows) are briefly described below to provide context for example embodiments of the reusable definitions of flow triggers discussed below.

### A. Task-Based Applications

Remote network management platform 320 may furnish various IT service management (ITSM) solutions including task-based applications designed to streamline and manage specific processes. Three examples are incident management, case management, and problem management.

Incident management focuses on the efficient resolution of IT service disruptions or incidents. When an issue or disruption occurs, it is logged as an incident in the incident management application. This application allows IT teams to track and manage these incidents throughout their lifecycles. It includes features such as incident creation/generation, assignment, prioritization, escalation, communication, and resolution. The incident management application provides workflows, notifications, and collaboration tools to facilitate the prompt and efficient addressing of incidents, with a goal of minimizing their impact on platform and system operations.

Case management is designed to handle diverse types of processes, requests, or workflows. It enables users to manage complex cases that require coordination across multiple groups. The case management application provides a unified platform to capture, track, and manage cases from initiation to resolution. It includes features such as case creation, classification, assignment, task tracking, collaboration, and closure. This application can be tailored to various use cases, such as HR inquiries, legal matters, facilities management, and customer support escalations among others.

Problem management is drawn to identifying and addressing the root causes of recurring incidents or issues. It helps IT teams identify underlying problems that lead to multiple incidents, analyze their impact, and initiate appropriate actions for resolution. The problem management application provides tools for problem identification, investigation, prioritization, and tracking. It allows users to link related incidents, perform root cause analysis, define workarounds or solutions, and track the progress of problem resolution. The application helps groups minimize the occurrence and impact of recurring issues, leading to improved service quality and stability for the platform and other systems.

### B. Workflows

As noted, task-based applications may employ or be integrated with workflows in some fashion. Here, a workflow defines a sequence of activities and operations used to automate and streamline processes. Workflows can be automated or semi-automated multi-step processes that occur between any combination of people and computing systems. These workflows may include conditions and branching logic, enabling different paths within the workflow based on specific criteria, such as the values or states of variables or data. A given organization can routinely use a large number of workflows for various purposes, such as HR onboarding, expense approvals, and IT incident management just to name a few.

Workflows can be integrated with other applications operable on remote network management platform 320, such as the task-based applications described above. This integration enables cross-application coordination and process synchronization. Further, remote network management platform 320 can integrate workflows with external systems and applications through web services or API calls. This allows for data exchange and collaboration with third-party tools, enabling end-to-end process automation and information sharing.

Remote network management platform 320 may include a workflow design application that allows users to create, modify, and manage workflows using a drag-and-drop user interface. The application provides a graphical representation of the workflow, making it easier to understand and configure the ordering of activities in the workflow. The application may also provide pre-built workflow templates and libraries that offer ready-to-use workflows for common processes. These templates can be customized to meet specific needs, thus accelerating the implementation of workflows.

Workflows may be defined by way of remote network management platform 320 as state diagrams. Thus, each workflow may have a number of states and transitions therebetween. Certain automated actions may be performed in various states, such as setting values, executing a script, sending a notification, starting or stopping a timer, communicating with third-party remote servers, transitioning to a different state, and so on. Other actions may be triggered by state transitions. Some of these actions may involve waiting for user input, while others could be automated.

Additionally, each workflow may have one or more triggers (e.g., starting rules) that causes the workflow to initiate. These triggers can be based on any one or more of: user actions (e.g., a user requests the workflow to initiate), time and/or a schedule (e.g., a computing system is configured to initiate the workflow once per day), system monitoring exceptions (e.g., detection of an error on system operation or a parameter crossing a pre-defined threshold value), and/or other events (e.g., changes to a filesystem or a database, reception of a message, calling of an API function).

These workflows may be executed by a computational instance (e.g., computational instance 322 of remote network management platform 320). Thus, users may interact with workflows by way of one or more user interfaces of the computational instance. This may involve a user being notified by the computational instance (e.g., via email) that their input is needed for a particular work item that is in a particular state of a workflow. The user can then log on to the computational instance and enter the requested input through an appropriate user interface. In some cases, the user may also be able to view other parts of the workflow related to the work item, e.g., its values or actions from other states and/or a representation of its history.

Workflows can be presented on a GUI through a combination of visual and interactive GUI elements. These workflows may be displayed using flowchart-like diagrams where each step in the workflow is represented by distinct nodes or icons. These nodes are connected by lines or arrows indicating the sequence of operations and the flow of data or actions from one step to the next. Each node may be labeled with a descriptive name and may include additional details or parameters that can be viewed or configured through pop-up windows or side panels.

Some workflows employ a step-by-step approach, presenting users with a series of interconnected pages (e.g., web pages) or screens that guide them through each stage of the workflow. Each page may focus on a specific task or set of related tasks. The GUI for such workflows often begins with a welcome or introductory screen that outlines the overall workflow and provides an overview of the steps involved. Navigation controls, such as “Next”, “Previous”, “Cancel”, and “Finish” buttons, may be displayed to allow movement forward and backward through the workflow or exit if necessary. Progress indicators, such as a step-by-step sidebar or breadcrumb trail, can be used to show the current position within the workflow and what steps remain.

Workflows may be implemented with program logic (e.g., scripts) that query specific fields of database tables for information relevant to the workflow and then provide this information along with further context for display by a GUI framework (e.g., a program or set of programs that produce a GUI from a programmatic specification thereof). In some cases, the database table names, field names, and GUI framework may be referenced indirectly by metadata. This allows a more flexible and implementation-independent interface between the program logic of the workflow and different types of databases and GUI frameworks.

### C. User Interface Building Tools

Remote network management platform 320 may provide a user interface builder application that is a visual design tool for creating and customizing user interfaces within the platform. This application may employ a low-code/no-code approach to designing intuitive GUIs, enabling administrators and developers to build user interface components without extensive coding knowledge.

Notably, low-code/no-code design refers to a development approach that enables the creation of software applications with minimal or no coding required. It involves using visual interfaces, drag-and-drop components, and declarative configuration instead of writing traditional lines of code.

Low-code platforms can provide a visual development environment that allows users to design and build applications through GUIs, pre-built components, and configuration options. They typically offer a set of pre-built functionalities and connectors to integrate with external systems, databases, and services. No-code platforms take the concept of low-code a step further by enabling users with little to no programming experience to create applications. These platforms offer a highly visual and intuitive interface where users can build applications using simple drag-and-drop actions, visual workflows, and configuration options. No-code platforms often provide a library of pre-built templates, modules, and integrations, allowing users to assemble and customize applications without writing any code.

Both low-code and no-code approaches aim to simplify and streamline the software development process, making it accessible to a broader range of users, including analysts, new developers, and subject matter experts. These approaches can empower non-technical users to create functional and scalable applications, reduce the reliance on traditional coding, and accelerate the development lifecycle.

To that point, the user interface builder application may include a drag-and-drop interface that simplifies the process of creating user interfaces. Users can add and arrange user interface components such as fields, buttons, containers, tables, and images onto the canvas, eliminating the need for manual coding. In doing so, the application may rely on a library of pre-built user interface components that users can choose from, including form fields, widgets, buttons, and navigation elements. These components can be added to the canvas and customized according to specific needs.

These user interface components may be bound to data sources within remote network management platform 320. This enables dynamic data display, real-time updates, and synchronization between the user interface and underlying data. The application also allows integration with other applications and workflows, as well as the use of conditional logic (e.g., visibility rules, triggering of actions, etc.) to create interactive and context-aware user interfaces.

### D. Virtual Agents

Remote network management platform 320 may also support virtual agents. These can be artificial-intelligence powered conversational interfaces designed to interact with users and provide automated assistance. Virtual agents can be integrated into various interfaces and applications, such as web portals, chat interfaces, and messaging platforms to offer self-service options and enhance the user experience. The virtual agents operable on remote network management platform 320 are different from the virtual agent features of a large language model (LLM). Notably, platform virtual agents may employ LLMs in some situations, but can also operate based on local platform content and pre-defined dialog trees, for example.

Virtual agents can engage in dynamic and context-rich conversations with users. They can guide users through predefined conversation flows, prompt for information, ask clarifying questions, and provide relevant responses or recommendations based on the user's needs. These virtual agents can be integrated with a knowledgebase, which contains a repository of articles, frequently-asked questions (FAQs), and troubleshooting information. Virtual agents can access this knowledgebase to retrieve relevant information and provide self-help resources to users. Virtual agents can also automate common tasks or processes within the platform. They can initiate workflows, create tasks, perform system actions, or provide status updates, allowing users to complete tasks without manual intervention.

Further, virtual agents can transfer conversations to live (human) agents when necessary or desirable. If a virtual agent cannot resolve a user's query or if the user requests human assistance, the conversation can be handed off to a live agent for further support and resolution. Such a handoff may involve providing, to the live agent, the context (and possibly some or all of the content) of the conversation between the user and the virtual agent.

### VIII. Example Workflow System

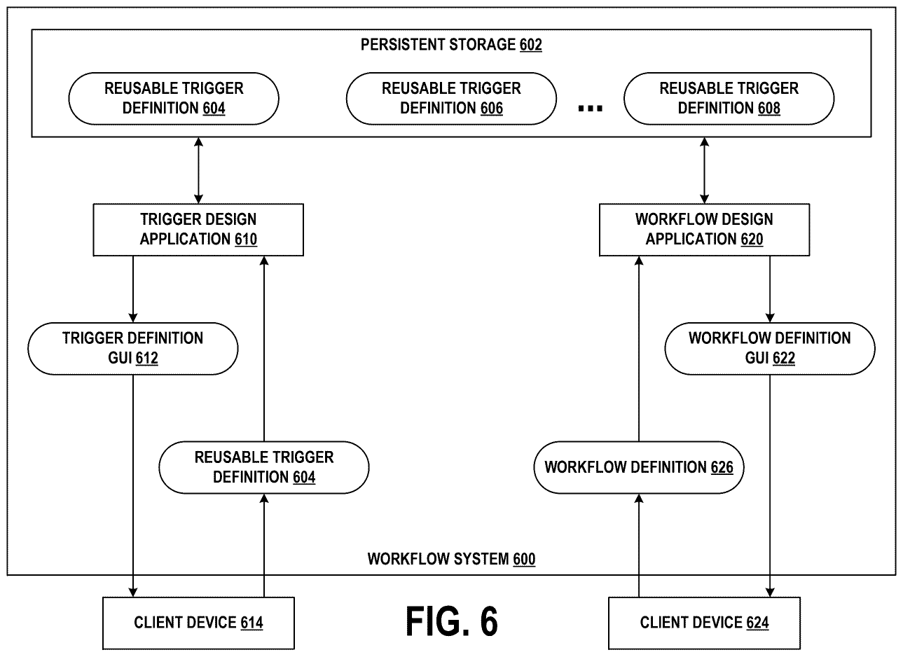

FIG. 6 illustrates an example workflow system 600 that may be used to define, store, and use reusable definitions of flow triggers. A flow trigger may alternatively be referred to as a workflow trigger, an instruction trigger, and/or simply as a trigger. Workflow system 600 may represent hardware, software, or a combination thereof. For example, workflow system 600 may represent the workflow design application(s) provided and/or executed by remote network management platform 320. Workflow system 600 may include persistent storage 602, trigger design application 610, and workflow design application 620, among other components not shown herein. Workflow system 600 may be accessed and/or used by client device 614 and client device 624.

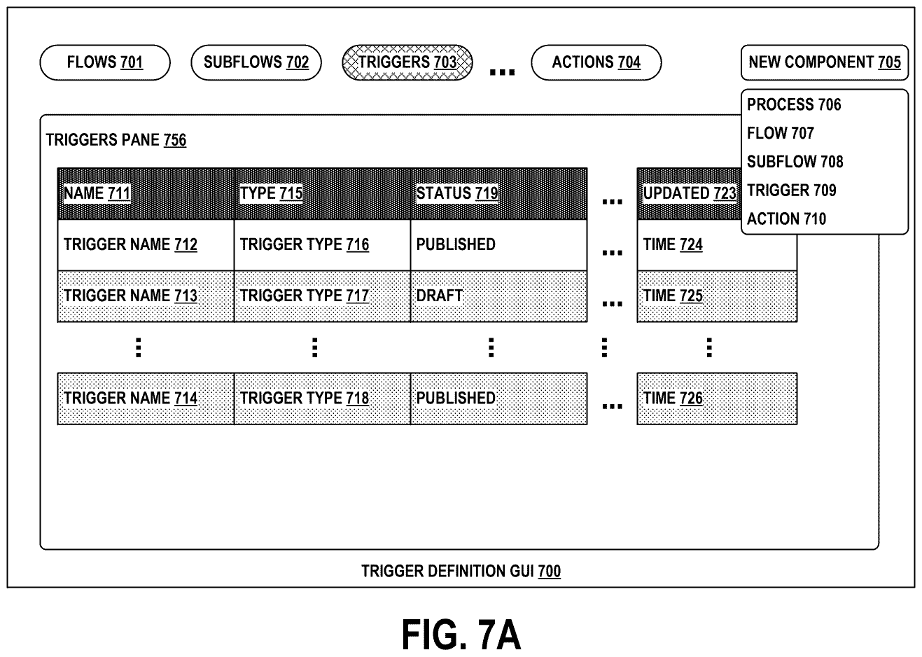

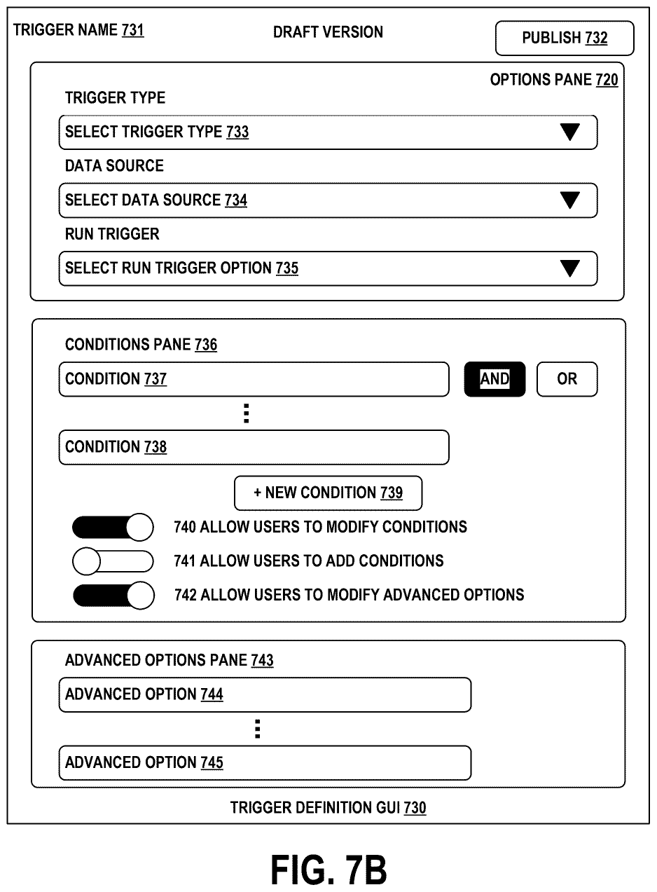

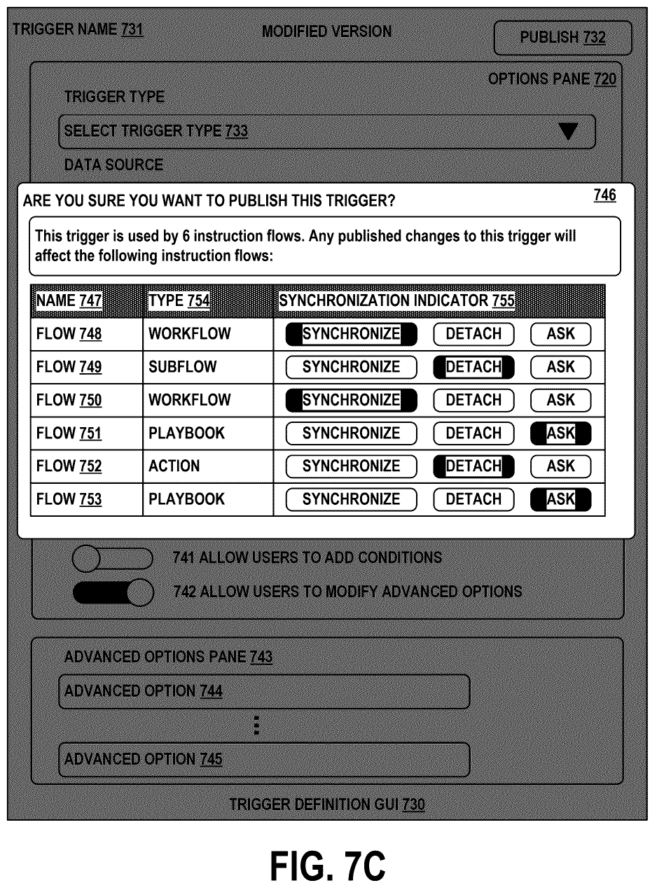

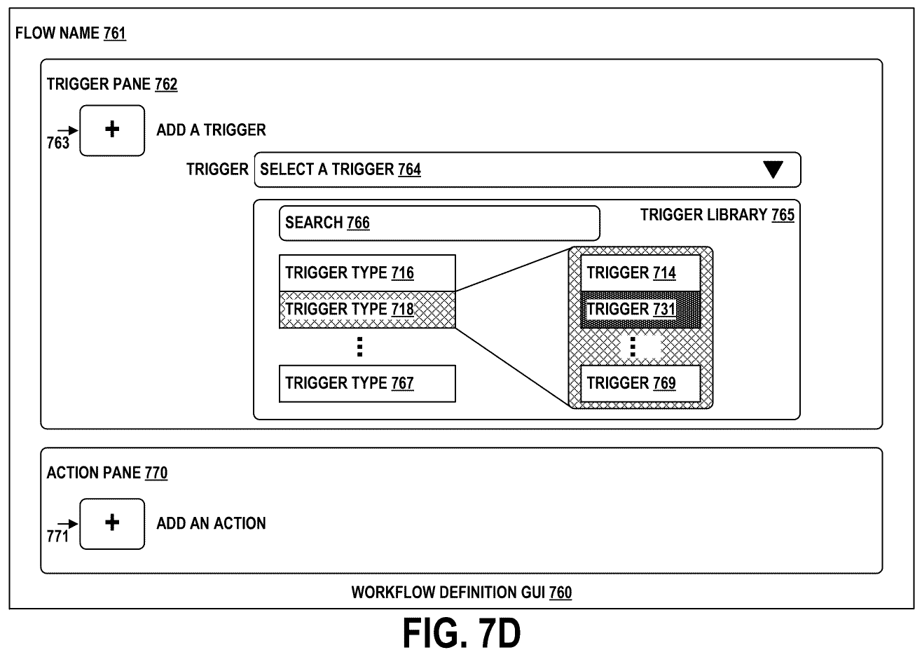

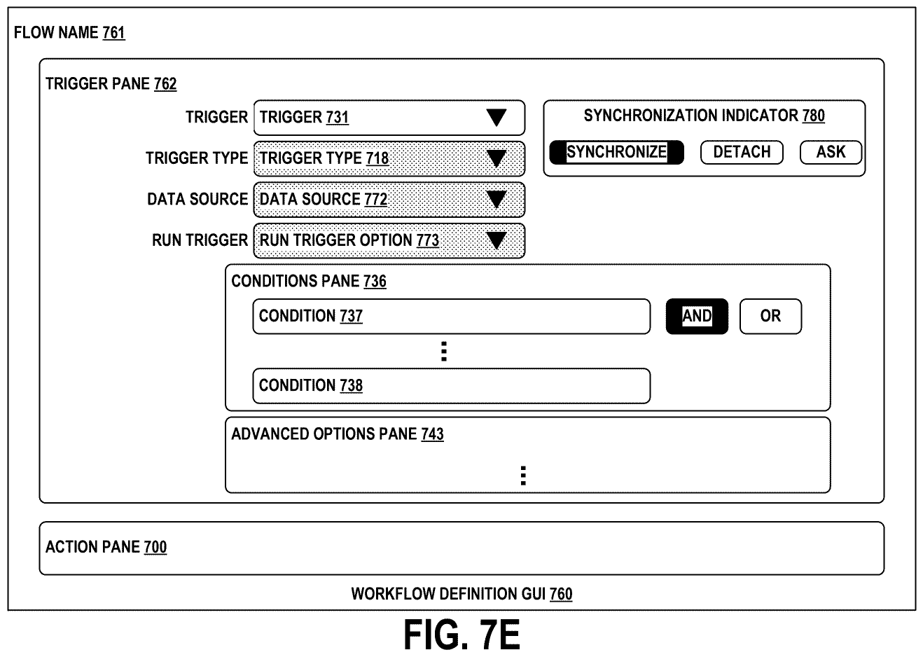

Specifically, trigger design application 610 may be configured to generate trigger definition GUI 612. Trigger definition GUI 612 may be configured to allow for definition of various flow triggers. Specifically, trigger definition GUI 612 may include various user interface (UI) components that can be arranged and/or modified to specify a desired logic and/or behavior for the flow trigger being defined using trigger definition GUI 612. FIGS. 7A, 7B, and 7C provide examples of various aspects of trigger definition GUI 612.

Workflow system 600 may be configured to provide trigger definition GUI 612 to client device 614 (e.g., based on and/or in response to a request therefor from client device 614), which may be configured to display trigger definition GUI 612. Client device 614 may be configured to obtain, using trigger definition GUI 612, a reusable definition of a flow trigger. The reusable definition of the flow trigger may be specified by a user through interactions with the various UI components of trigger definition GUI 612. For example, client device 614 may receive reusable trigger definition 604 of a corresponding flow trigger.

Based on and/or in response to reception of reusable trigger definition 604, client device 614 may be configured to provide reusable trigger definition 604 to trigger design application 610. Reusable trigger definition 604 may provide a structured and/or programmatic representation of the trigger logic/behavior defined through user inputs obtained by way of trigger definition GUI 612. Reusable trigger definition 604 may specify one or more conditions that, when met, cause execution of one or more instructions of a workflow in which reusable trigger definition 604 is used. That is, reusable trigger definition 604 may specify one or more conditions that, when met, cause the corresponding flow trigger to be engaged, activated, and/or triggered.

Based on and/or in response to reception of reusable trigger definition 604, trigger design application 610 may be configured to store reusable trigger definition 604 in persistent storage 602. Persistent storage 602 may include a plurality of reusable trigger definitions. For example, persistent storage 602 may include reusable trigger definition 604 and reusable trigger definition 606 through reusable trigger definition 608 (“reusable trigger definitions 604-608”). At least some of the reusable trigger definition stored in persistent storage 602 may be designated as “published,” and may thus be available for integration into workflows defined using workflow design application 620.

Workflow design application 620 may be configured to generate workflow definition GUI 622. Workflow definition GUI 622 may be configured to allow for definition of various workflows. Specifically, workflow definition GUI 622 may include various user interface components that can be arranged and/or modified to specify a desired logic and/or behavior of the workflow. Workflow definition GUI 622 may include graphical representations of reusable trigger definitions 604-608 stored in persistent storage 602. For example, workflow definition GUI 622 may include a list, icons, a search bar, and/or other types of UI components configured to facilitate browsing and/or searching through reusable trigger definitions 604-608. FIGS. 7D and 7E provide examples of various aspects of workflow definition GUI 622.

The term “instruction flow” is used herein to collectively refer to workflows, subflows, actions, playbooks, and/or any other sequences of one or more instructions generated using workflow system 600. Workflows are discussed herein as a representative example of instruction flows.

Workflow system 600 may be configured to provide workflow definition GUI 622 to client device 624 (e.g., based on and/or in response to a request therefor from client device 624), which may be configured to display workflow definition GUI 622. Client device 624 may be configured to obtain, using workflow definition GUI 622, a workflow definition. The workflow definition may be specified by a user through interactions with the various UI components of workflow definition GUI 622. For example, client device 624 may receive workflow definition 626, which may include and/or be based on reusable trigger definition 604. Thus, in the example illustrated in FIG. 6, reusable trigger definition 604 and workflow definition 626 may be specified using different client devices and/or by different users. In other implementations, both reusable trigger definition 604 and workflow definition 626 may be specified using the same client device and/or by the same user.

Based on and/or in response to reception of workflow definition 626, client device 624 may be configured to provide workflow definition 626 to workflow design application 620. Workflow definition 626 may provide a structured and/or programmatic representation of the workflow logic/behavior defined through user inputs obtained by way of workflow definition GUI 622. Based on and/or in response to reception of workflow definition 626, workflow design application 620 may be configured to store workflow definition 626 in persistent storage (not shown). Once stored in persistent storage 602, the workflow defined by workflow definition 626 may be ready for execution.

Each of reusable trigger definitions 604-608 may be flow-independent and/or flow-agnostic, and may thus be used as part of multiple different workflows. That is, each of reusable trigger definitions 604-608 may be able to be configured “out-of-the-box” (i.e., without requiring any modifications to the trigger definition) to be integrated into any workflow defined using workflow system 600, regardless of the function, structure, and/or purpose of the workflow. For example, each respective flow trigger of reusable trigger definitions 604-608 may be configured to indicate whether the corresponding trigger condition(s) have been met (i.e., whether the flow trigger is active/engaged/triggered) in the same or similar manner as other flow triggers, thus allowing each respective flow trigger to be compatible with any workflow.

In general, a workflow trigger may include one or more conditions that may be based on data generated by remote network management platform 320, managed network 300, and/or a third-party computing system. As one example, a first reusable trigger definition of reusable trigger definitions 604-608 may be configured to listen for events from a source code version control system (e.g., GITHUB, JIRA, etc.). The flow trigger may be engaged/activated/triggered when a specified even occurs (e.g., a commit is made to a master branch of particular source code).

As another example, a second reusable trigger definition of reusable trigger definitions 604-608 may be configured to call (e.g., periodically) an API to obtain data therefrom and/or provide data thereto. The flow trigger may be engaged/activated/triggered when the data meets criteria defined by the flow trigger, thus allowing for integration with, for example, a weather service, a payment service, and/or a social media platform, among others.

As a third example, a third reusable trigger definition of reusable trigger definitions 604-608 may be configured to listen for messages on specific topics, with specific subject, and/or with specific contents (e.g., as transmitted using email, APACHE KAFKA, SERVICENOW Now Message Queue, Simple Object Access Protocol (SOAP) messaging, etc.). The flow trigger may be engaged/activated/triggered when a specified message is detected.

Other systems and/or events that may be utilized by reusable trigger definitions 604-608 may include record-based events (e.g., CRUD events), GRAPHQL, SERVICENOW MetricBase, record watchers, various UI events and/or interactions, and/or polling of external systems, among other possibilities.

### IX. Example User Interfaces

FIG. 7A illustrates aspects of an example trigger definition GUI 700, which may form part of trigger definition GUI 612. Trigger definition GUI 700 may include flows button 701, subflows button 702, triggers button 703, actions button 704, and new component button 705, among others. Selection of triggers button 703 (as indicated by the hatched pattern in FIG. 7A) may be configured to cause trigger definition GUI 700 to display triggers pane 756, which may be configured to list information about reusable trigger definitions that are stored in persistent storage 602. Similarly, selection of flows button 701, subflows button 702, and/or actions button 704 may be configured to cause trigger definition GUI 700 to display one or more other panes containing details about available flows, subflows, and/or actions, respectively.

Triggers pane 756 may include name column 711, type column 715, status column 719, and updated column 723. Name column 722 may indicate a name of a respective reusable definition of a flow trigger, and may include trigger name 712 and trigger name 713 through trigger name 714 (“trigger names 712-714”) for the reusable trigger definitions stored in persistent storage 602. Type column 715 may indicate a type, class, and/or scope of the respective reusable definition of the flow trigger and/or a type, class, and/or scope of software applications to which the respective reusable definition of the flow trigger is available. Thus, the reusable trigger definitions stored in persistent storage 602 may be divided into one or more groups to facilitate the search and selection of an appropriate reusable definition for a given software application. Type column 715 may include trigger type 716 and trigger type 717 through trigger type 718 (“trigger types 716-718”) corresponding to trigger names 712-714, respectively.

Status column 719 may indicate whether the respective reusable definition of the flow trigger is in a published state (and thus available for integration into workflows), a draft state (and thus not yet completed), and/or another possible state. For example, the reusable definitions associated with trigger names 712 and 714 are indicated as “PUBLISHED,” while the reusable definition associated with trigger name 713 is indicated as “DRAFT.” Updated column 723 may indicate a time at which the respective definition of the flow trigger has last been updated or modified. Updated column 723 may include time 724 and time 725 through time 726 (“time 724-726”) corresponding to trigger names 712-714, respectively. Trigger pane 756 may additionally or alternatively be configured to display other information about the reusable definitions of the flow triggers stored in persistent storage 602.

New component button 705 may allow trigger definition GUI 700 to display a list of one or more workflow component types that could be added using workflow system 600. For example, selection of new component button 705 may cause trigger definition GUI 700 to display a list of buttons for new component types, including process button 706, flow button 707, subflow button 708, trigger button 709, and action button 710, among others. Selection of trigger button 709 from the list may cause the client device to display trigger definition GUI 730, as illustrated in FIG. 7B.

Turning to FIG. 7B, trigger definition GUI 730 may include a plurality of graphical UI components that allow for specification of a new reusable definition of a flow trigger and/or modification of an existing reusable definition. Specifically, trigger definition GUI 730 may include trigger name 731 (which may be editable using trigger definition GUI 730 and/or other GUIs), and may indicate that the new reusable definition is in a draft state. Trigger definition GUI 730 may also include publish button 732 that, when selected, is configured to cause workflow system 600 to store, in persistent storage 602, a published version of the reusable definition of the flow trigger as specified using trigger definition GUI 730.

Trigger definition GUI 730 may further include options pane 720, conditions pane 736, and advanced options pane 743. These and other panes and/or components of trigger definition GUI 730 may allow a user to specify the desired logic/behavior of a flow trigger. Specifically, options pane 720 may include trigger type dropdown 733 that allows for selection of a type, class, and/or scope of the reusable definition of the flow trigger. For example, trigger type dropdown 733 may include a MICROSOFT® trigger category, a Continuous Integration trigger category, a “record created” trigger category, a “record updated” trigger category, a “record created or updated” trigger category, an external webhook trigger category, a MetricBase trigger category, an inbound email trigger category, an APACHE KAFKA trigger category, and/or a polling trigger category, among others. In some implementations, the types, classes, and/or scopes available from trigger type dropdown 733 may be modifiable to arrange and/or rearrange the reusable definitions of flow triggers in various ways (e.g., according to user and/or developer preferences).

Options pane 720 may also include data source dropdown 734 that allows for selection of a data source used in determining whether one or more conditions of the flow trigger have been met. Data source dropdown 734 may include a list of internal data sources that are available within a computational instance used to execute workflow system 600 and/or external data sources that are accessible to the computational instance, among other possibilities. The data sources may include, for example, tables in a database, APIs, and/or software applications, among others. Options pane 720 may further include run trigger option dropdown 735 that allows for specification of how the flow trigger is executed when the one or more conditions thereof have been met. For example, run trigger option dropdown 735 may include a “run once” option, a “run for every unique change” option, a “run only if not currently running” option, and/or a “run for every update” option, among other possibilities.

In some cases, the number of data sources available in data source dropdown 734 may be large (e.g., on the order of hundreds or thousands), with each data source having multiple different entries that could be used by the flow trigger. Accordingly, it may be relatively difficult to determine which data source and/or entry thereof should be used to achieve a desired trigger behavior. Thus, a developer that is familiar with and/or skilled at using a given data source may define a particular reusable trigger once, thereby allowing users that are less familiar with and/or less skilled at using the given data source to utilize the particular flow trigger without having to familiarize themselves with the given data source.

Conditions pane 736 may be used to specify condition 737 through condition 738 (“conditions 737-378”), and may include new condition button 739 and options 740, 741, and 742. Conditions 737-738 may specify when the flow trigger is engaged (i.e., triggered), and may be based on one or more data sources selected using data source dropdown 734. Conditions 737-738 may include Boolean operators, comparison operators, and/or other mathematical operators configured to define when the flow trigger is to be activated/engaged (and conversely deactivated/disengaged). For example, conditions pane 736 indicates that condition 737 is AND'ed with a condition subsequent thereto. In some implementations, conditions pane 736 may allow one or more scripts to be added to the flow trigger, and/or may provide tools for parsing structured responses and/or payloads (e.g., JSON), among other functions.

New condition button 739 may be used to initiate the addition of conditions 737-738 and/or one or more other conditions (not shown). For example, selection of new condition button 739 may cause conditions pane 736 to display a new modifiable condition that can be configured to define at least part of the behavior of the flow trigger.

Options 740-742 may be used to indicate the extent of modifiability of workflow-specific copies of the flow trigger when such workflow-specific copies are being integrated into a workflow. Workflow-specific copies of the flow trigger may alternatively be referred to as non-reusable copies of the flow trigger. Workflow-specific copies of the flow trigger may be based on the reusable definition of the flow trigger, but may be detached therefrom such that modifications to the workflow-specific copies do not affect the reusable definitions. Option 740, when engaged as shown in FIG. 7B, may allow users to modify conditions 737-738 of a workflow-specific copy of the flow trigger when adding the flow trigger to a workflow. Option 741, when engaged (option 741 is shown disengaged in FIG. 7B), may allow users to add conditions to the workflow-specific copy of the flow trigger when adding the flow trigger to a workflow. Option 742, when engaged as shown in FIG. 7B, may allow users to modify the advanced options (specified in advanced options pane 743) of the workflow-specific copy of the flow trigger when adding the flow trigger to a workflow.

Advanced options pane 743 may be configured to allow for specification of various advanced options, such as advanced options 744-745. Advanced options 744-745 may include any options that are classified and/or designated as advanced, and thus reserved for more experienced users. Advanced options 744-745 may indicate, for example, whether to run the flow as a background process, indicate whether to run the flow for interactive and/or non-interactive sessions, and/or include scripts to be executed as part of the flow trigger, among other possibilities.

Once specification of the reusable definition of the flow trigger via trigger definition GUI 730 is completed, publish button 732 may be selected to add the reusable definition to persistent storage 602. That is, publish button 732 may be used to make the reusable definition available to various workflows defined using workflow system 600.

After the reusable definition of the flow trigger is published, it may be desirable to modify one or more aspects of the reusable definition. For example, it may be desirable to add new condition(s), remove one or more of conditions 737-738, and/or modify options 740-742, among other possibilities. Modifying the reusable definition may improve the performance of the flow trigger, adapt the flow trigger to changes in other systems, and/or facilitate debugging of the flow trigger, among other possibilities. However, the reusable definition of the flow trigger may be integrated into one or more instruction flows after initial publication of the flow trigger and before the subsequent modification thereof, and such modifications may therefore affect these one or more instruction flows (e.g., change when/how workflows are initiated, introduce errors into the workflows, etc.). Accordingly, FIG. 7C illustrates additional aspects of trigger definition GUI 730 that may be used to facilitate the process of modifying the reusable definition of the flow trigger.

Specifically, trigger definition GUI 730 may include popup window 746 that is configured to provide a list of one or more instruction flows that utilize the reusable definition. In some implementations, popup window 746 may be displayed before any modifications are made to the reusable definition to, for example, allow the utilization of the existing version of the reusable definition to inform the scope of any modifications. In other implementations, popup window 746 may be displayed after modifications are made to the reusable definition but before these modifications are published (i.e., saved in persistent storage 602) to, for example, allow the scope of the modifications to inform the extent of synchronization of the modifications with various instruction flows.

In the example of FIG. 7C, popup window 746 indicates that the reusable definition is used by six instruction flows. For example, popup window 746 may include a table that provides, for each respective instruction flow that utilizes the reusable definition undergoing modification (and that may thus be affected by the modification), a name of the instruction flow, a type of the instruction flow, and a synchronization indicator for the instruction flow. Thus, the table may include name column 747, type column 754, and synchronization indicator column 755.

Name column 747 may list flows 748, 749, 750, 751, 752, and 753 (“flows 748-753”), and type column 754 may indicate that flows 748 and 750 are workflows, flow 749 is a subflow, flows 751 and 753 are playbooks, and flow 753 is an action. Synchronization indicator column 755 may provide, for each respective flow of flows 748-753, a selectable synchronization indicator that allows a user to indicate the extent and/or manner of synchronization between the reusable definition of the flow trigger as modified and each of flows 748-753.

For example, the synchronization indicator of each respective flow of flows 748-753 may include (i) a “synchronize” value that, when selected, indicates that the modification to the reusable definition is to be used to update the respective flow, (ii) a “detach” value that, when selected, indicates that the modification to the reusable definition is not to be used to update the respective flow (i.e., the respective flow is to continue using the current/unmodified reusable definition of the flow trigger), and (iii) an “ask” value that, when selected, indicates that one or more users associated with the respective flow (e.g., an author or administrator of the respective flow) are to be asked about whether the modification to the reusable definition is to be used to update the respective flow.

FIG. 7C illustrates that the “synchronize” value of the synchronization indicator is selected for each of flows 748 and 750, the “detach” value of the synchronization indicator is selected for each of flows 749 and 752, and the “ask” value of the synchronization indicator is selected for each of flows 751 and 753. Thus, flows 748 and 750 will be updated based on any modifications to the reusable definition, flows 749 and 752 will retain their current version of the reusable definition of the flow trigger, and flows 751 and 753 may or might not be updated depending on whether the one or more users associated with these flows accept or reject the modifications. Using the synchronization indicator may thus allow the latest updates to the flow trigger to be propagated to some instruction flows and held back from other instruction flows to, for example, maintain the integrity and/or functionality of various instruction flows (e.g., preventing modifications to the flow trigger from “breaking” the instruction flows).

FIG. 7D illustrates an example workflow definition GUI 760, which may form part of workflow definition GUI 622. Workflow definition GUI 760 may include a name for flow 761 that identifies the workflow being defined using workflow definition GUI 760, trigger pane 762 and action pane 770. Trigger pane 762 may include button 763 configured to initiate the process of adding a trigger to the workflow. Specifically, interaction with (e.g., selection of) button 763 may cause trigger pane 762 to display trigger selection component 764. Interaction with trigger selection component 764 may cause trigger pane 762 to display trigger library 765, which may include search bar 766 and a list of plurality of types of reusable definitions of flow triggers that are available for integration into flow 761.

The plurality of types of reusable definitions of flow triggers may include trigger type 716 and trigger type 718 through trigger type 767 (“trigger types 716-767”). Trigger types 716-767 may include each of the published trigger types shown in FIG. 7A and the type of trigger defined using FIGS. 7B and 7C, among others. Interaction with trigger type 718 may cause trigger library 765 to display a plurality of triggers, including trigger 714 and trigger 731 through trigger 769 (“triggers 714-769”), each of which is classified as having trigger type 718. Similarly, interaction with other ones of trigger types 716-767 may cause trigger library 765 to display corresponding pluralities of triggers.

A respective flow trigger of triggers 714-769 may be added to flow 761 by selecting the respective flow trigger from trigger library 765. For example, FIG. 7D indicates, using a dark fill pattern, that trigger 731 has been selected from trigger library 765 for inclusion in flow 761. Since trigger 731 is associated with a reusable definition thereof, trigger 731 may already be completely predefined in a flow-independent manner, and may thus be added to the workflow by selecting trigger 731 from trigger library 765 and without modifying the reusable definition of trigger 731. That is, adding trigger 731 to the workflow may be as simple as finding trigger 731 in trigger library 765 and selecting the graphical representation thereof (e.g., using a total of 4 interactions or clicks).

Workflow definition GUI 760 may also include action pane 770, which may include button 771 for initiating the process of adding operations and/or actions to the workflow. One or more of these operations/actions may be executed based on and/or in response to engagement of trigger 731 specified using trigger pane 762. In some implementations, a flow trigger may additionally or alternatively be added as part of and/or following one or more of the actions added to action pane 770.

FIG. 7E illustrates an arrangement of workflow definition GUI 760 that may be displayed after selection of trigger 731 from trigger library 765. Specifically, trigger pane 762 may be populated with at least some information from the reusable definition of trigger 731, with some parts thereof indicated as modifiable (using a white color fill) and other parts thereof indicated as unmodifiable (using a dark fill pattern), depending on options set during specification of the reusable definition. For example, trigger pane 762 may indicate that trigger 731 is associated with trigger type 718 (unmodifiable), data source 772 (unmodifiable), run trigger option 773 (unmodifiable), conditions 737-738 (modifiable), and various advanced options (modifiable) indicated by the ellipsis in advanced options pane 743. Thus, trigger pane 762 may allow aspects of trigger 731 to be customized (as permitted by the reusable definition thereof) to define a workflow-specific version of trigger 731. However, since the reusable definition of trigger may already be complete, trigger 731 may operate as part of the workflow without any further modifications.

Workflow definition GUI 760 may also include synchronization indicator 780 for trigger 731. Synchronization indicator 780 may be similar to the synchronization indicators discussed in connection with synchronization indicator column 755, but may be provided when defining a workflow rather than when modifying the reusable definition of trigger 731. Both the flow-side and the trigger-side synchronization indicators may be used in combination. When both the flow-side and the trigger-side synchronization indicators are equal, modifications to the reusable definition may be used to update the flow as indicated by both synchronization indicators.

When synchronization indicator 780 is set to “detach,” flow 761 might not be presented as part of popup window 746 when modifying trigger 731 (since the author of flow 761 chose to detach flow 761 from all changes to the reusable definition of trigger 731). When synchronization indicator 780 is set to “synchronize,” flow 761 may be presented as part of popup window 746 when modifying trigger 731 and the synchronization indicator selected using popup window 746 may override synchronization indictor 780 (since the individual modifying trigger 731 may be in a better position to determine whether the modifications are expected to break flow 761). When synchronization indicator 780 is set to “ask,” flow 761 may be presented as part of popup window 746 when modifying trigger 731 and synchronization indictor 780 may override the synchronization indicator selected using popup window 746 (since the author of flow 761 may wish to permit only some changes to trigger 731 to be propagated to flow 761). Thus, the flow-side and the trigger-side synchronization indicators may allow the flow trigger author and/or the workflow author to determine how best to manage flow trigger updates for various workflows (e.g., to prevent the introduction of software errors and/or incompatibilities).

### X. Example Message Flow Diagrams

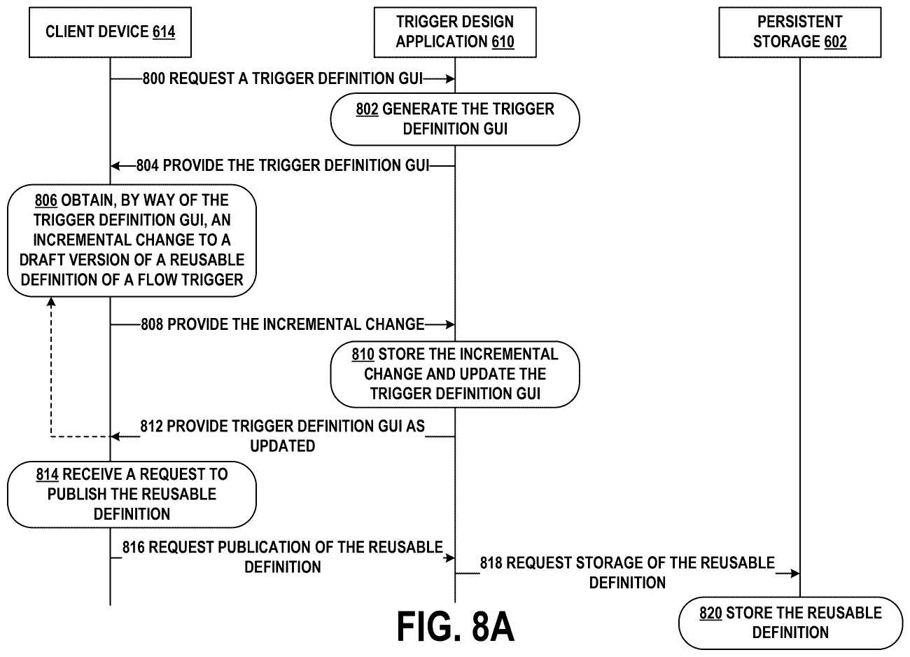

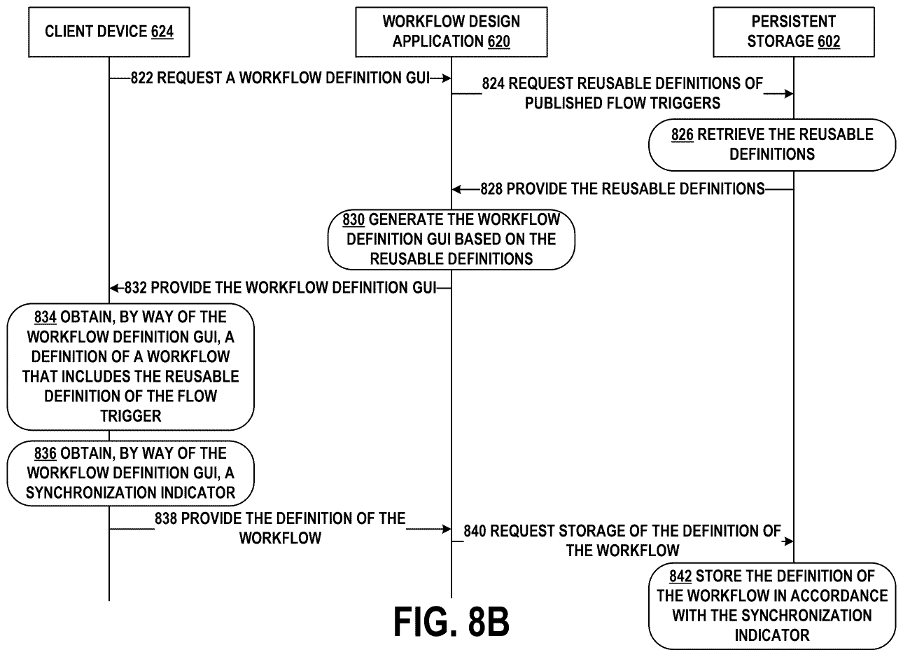

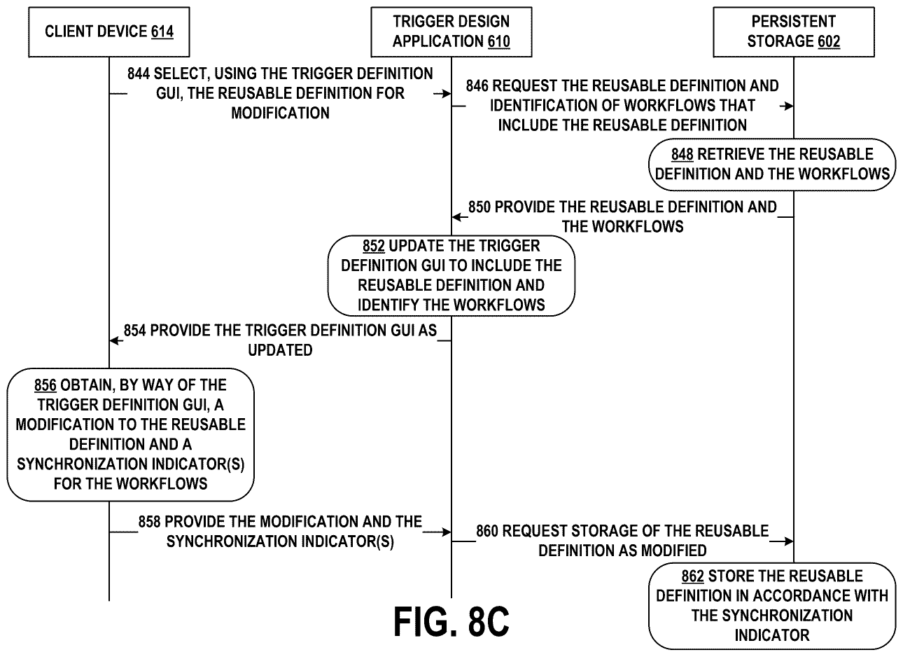

FIGS. 8A, 8B, and 8C illustrate example message flow diagrams related to the creation and use of reusable definitions of flow triggers. Specifically, FIG. 8A illustrates operations involved in specifying a reusable definition of a flow trigger, FIG. 8B illustrates operations involved in adding the reusable definition to a workflow, and FIG. 8C illustrates operations involved in modifying the reusable definition of the flow trigger.

Turning to FIG. 8A, client device 614 may be configured to request, from trigger design application 610, a trigger definition GUI, as indicated by arrow 800. For example, the request at arrow 800 may be generated based on selection of new component button 705 and/or trigger button 709 from trigger definition GUI 700. Based on and/or in response to reception of the request at arrow 800, trigger design application 610 may be configured to generate the trigger definition GUI (e.g., trigger definition GUI 612), as indicated by block 802. Based on and/or in response to generation of the trigger definition GUI at block 802, trigger design application 610 may be configured to transmit the trigger definition GUI to client device 614, as indicated by arrow 804. The trigger definition GUI may include and/or be similar to trigger definition GUI 730.

Client device 614 may use the trigger definition GUI to obtain an incremental change to a draft version of a reusable definition of a flow trigger, as indicated by block 806. For example, a user of client device 614 may interact with trigger definition GUI to specify the incremental change to the draft version. The incremental change may include, for example, a selection and/or specification of values for one or more components shown in trigger definition GUI 730.

Based on and/or in response to reception of the incremental change at block 806, client device 614 may be configured to provide the incremental change to trigger design application 610, as indicated by arrow 808. Based on and/or in response to reception of the incremental change at arrow 808, trigger design application 610 may be configured to store the incremental change and update the trigger definition GUI, as indicated by block 810. Storing the incremental change, and the resulting partial reusable definition of the flow trigger, may allow trigger design application 610 to prevent loss of progress in defining the trigger should client device 614 disconnect from trigger design application 610.

Based on and/or in response to updating the trigger definition GUI at block 810, trigger design application 610 may be configured to provide, to client device 614, the trigger definition GUI as updated, as indicated by arrow 812. Thus, client device 614 may visually represent the progress made in specifying the reusable definition of the flow trigger. The operations of block 806 through arrow 812 may be repeated one or more times until, for example, a complete definition of the flow trigger is specified using the trigger definition GUI.

Client device 614 may be configured to receive, using the trigger definition GUI, a request to publish the reusable definition, as indicated by block 814. For example, the request to publish the reusable definition may be based on selection of button 732 from trigger definition GUI 730. Based on and/or in response to reception of the request to publish the reusable definition at block 814, client device 614 may be configured to request publication of the reusable definition by trigger design application 610, as indicated by arrow 816. Based on and/or in response to reception of the request at arrow 816, trigger design application 610 may be configured to request storage of the reusable definition in persistent storage 602, as indicated by arrow 818. Based on and/or in response to reception of the request at arrow 818, persistent storage 602 may be configured to store the reusable definition, as indicated by block 820. Once stored in persistent storage, the reusable definition may be available for integration into workflows, as discussed in FIG. 8B.

Turning to FIG. 8B, client device 624 may be configured to request a workflow definition GUI from workflow design application 620, as indicated by arrow 822. Based on and/or in response to reception of the request at arrow 822, workflow design application 620 may be configured to request, from persistent storage, reusable definitions of published flow triggers, as indicated by arrow 824. Based on and/or in response to reception of the request at arrow 824, persistent storage 602 may be configured to retrieve the reusable definitions, as indicated by block 826. Based on and/or in response to retrieval of the reusable definitions at block 826, persistent storage may be configured to provide the reusable definitions to workflow design application 620, as indicated by arrow 828.

Based on and/or in response to reception of the reusable definitions at arrow 828, workflow design application 620 may be configured to generate the workflow definition GUI based on the reusable definitions, as indicated by block 830. For example, the workflow definition GUI may include and/or be similar to workflow definition GUI 760. Based on and/or in response to generation of the workflow definition GUI at block 830, workflow design application 620 may be configured to provide the workflow definition GUI to client device 624, as indicated by arrow 832.

Based on and/or in response to reception of the workflow definition GUI at arrow 832, client device 624 may be configured to use the workflow definition GUI to obtain a definition of a workflow that includes the reusable definition of the flow trigger, as indicated by block 834. For example, a user of client device 624 may interact with workflow definition GUI to select the reusable definition of the flow trigger, thereby instructing that the reusable definition of the flow trigger form part of the workflow. The user of client device 624 may also interact with workflow definition GUI to specify other instructions that form part of the workflow, including instructions that precede and/or instructions that are executed in response to the flow trigger.

Client device 624 may also be configured to use the workflow definition GUI to obtain, for the workflow defined at block 834, a synchronization indicator, as indicated by block 836. The synchronization indicator may indicate whether and/or how future modifications to the reusable definition of the flow trigger are to be propagated to and/or used to update the workflow defined at block 834. The synchronization indicator may be provided using, for example, a checkbox, toggle, a dropdown, and/or other UI component that allows for selection and/or specification of two or more values for the synchronization indicator. The synchronization indicator may have a value of “synchronize,” “detach,” and/or “ask before synchronizing.” Synchronization indicator 780 of FIG. 7E provides one example of the synchronization indicator that may be received at block 836.

Specifically, when the synchronization indicator indicates that the workflow is to be synchronized with the reusable definition of the flow trigger (e.g., when the synchronization indicator has a value of “synchronize”), modifications to the flow trigger may be automatically propagated to the workflow such that the workflow always includes the latest version of the flow trigger. When the synchronization indicator indicates that the workflow is to be detached from the reusable definition of the flow trigger (e.g., when the synchronization indicator has a value of “detach”), a current version of the reusable definition of the flow trigger may be added to the workflow and the current version might not be affected by future modifications to the flow trigger. When the synchronization indicator indicates that workflow system 600 is to ask before synchronizing any modifications (e.g., when the synchronization indicator has a value of “ask” “ask before synchronizing”), workflow system 600 may be configured to notify an author or administrator of the workflow that an updated version of the reusable definition of the flow trigger is available, and prompt the author or administrator for permission to update the workflow based on the reusable definition of the flow trigger as updated. Thus, a developer, designer, programmer, author, and/or administrator of the workflow may control the extent and/or manner of synchronization between the workflow and the reusable definition.

In some implementations, the operations of block 834 may involve obtaining one or more changes to the flow trigger. For example, the flow trigger may be modified by the removal and/or addition of conditions to the flow trigger. Any modifications to the flow trigger as part of the workflow may be saved as part of a workflow-specific representation of the flow trigger, but might not affect the reusable definition of the flow trigger. In such cases, the reusable definition of the flow trigger may be used as a starting point, and may be modified as needed to provide various workflow-specific conditions that are not part of the reusable definition, thus providing both reusability and customizability.

Based on and/or in response to obtaining the definition of the workflow at block 834 and/or the synchronization indicator at block 836, client device 624 may be configured to provide the definition of the workflow (which includes the synchronization indicator) to workflow design application 620, as indicated by arrow 838. Based on and/or in response to reception of the definition of the workflow at arrow 838, workflow design application 620 may be configured to request storage of the definition of the workflow in persistent storage 602, as indicated by arrow 840.

Based on and/or in response to reception of the request at arrow 840, persistent storage 602 may be configured to store the definition of the workflow in accordance with the synchronization indicator, as indicated by block 842. For example, when the synchronization indicator indicates that the workflow is to be detached from the reusable definition, persistent storage 602 may store a workflow-specific copy of the reusable definition of the flow trigger as part of the workflow. When the synchronization indicator indicates that the workflow is to be synchronized with the reusable definition, persistent storage 602 may store a reference to the reusable definition of the flow trigger as part of the workflow (but might not store the reusable definition itself so as not to create unnecessary copies thereof). When the synchronization indicator indicates that synchronization permission is to be obtained for each update to the reusable definition, persistent storage 602 may store the workflow-specific copy of the reusable definition of the flow trigger, which may be replaced with an updated version thereof each time permission is granted to synchronize a modified version of the reusable definition.

Turning to FIG. 8C, client device 614 may be configured to select, using the trigger definition GUI the reusable definition of the flow trigger for modification, as indicated by arrow 844. Based on and/or in response to reception of the selection at arrow 844, trigger design application 610 may be configured to request, from persistent storage 602, the reusable definition and identification of workflows that include the reusable definition, as indicated by arrow 846. Trigger design application 610 may request identification of the workflows that include the reusable definition to determine and present (e.g., to a user of client device 614) the extent/impact that any modifications to the reusable definition may have.

Based on and/or in response to reception of the request at arrow 846, persistent storage 602 may be configured to retrieve the reusable definition and the identification of the workflows that include the reusable definition, as indicated by block 848. Based on and/or in response to the retrieval at block 848, persistent storage 602 may be configured to provide the reusable definition and the identification of the workflows to trigger design application 610, as indicated by arrow 850.

Based on and/or in response to reception of the reusable definition and the identification of the workflows at arrow 850, trigger design application 610 may be configured to update the trigger definition GUI to include the reusable definition and identify the workflows that utilize the reusable definition, as indicated by block 852. The updated trigger definition GUI may include and/or be similar to trigger definition GUI 730 as illustrated in FIG. 7C and may thus include popup window 746.

Based on and/or in response to updating the trigger definition GUI at block 852, trigger design application 610 may be configured to provide, to client device 614, the trigger definition GUI as updated, as indicated by arrow 854. Based on and/or in response to reception at arrow 854 of the trigger definition GUI as updated, client device 614 may be configured to obtain, by way of the trigger definition GUI as updated, a modification to the reusable definition, as indicated by block 856. For example, the user of client device 614 may interact with trigger definition GUI as updated to modify the reusable definition by, for example, adding new conditions, removing existing conditions, and/or changing options associated with the workflow trigger, among other possibilities.

In some implementations, client device 614 may also be configured to obtain, by way of the trigger definition GUI as updated and for each respective workflow of the workflows, a corresponding synchronization indicator for the respective workflow, as indicated by block 856. The synchronization indicator obtained at block 856 may be similar to the synchronization indicator obtained at block 836 (e.g., both may have a value of “synchronize,” “detach,” or “ask before synchronizing”), but different values may be selected at each of blocks 836 and 856 for a given workflow. Synchronization indicator column 755 of FIG. 7C provides examples of the synchronization indicators that may be received at block 856.

In some cases, the trigger definition GUI may indicate the workflows that utilize the reusable definition (and may thus be affected by modifications thereto) prior to receiving any modifications to the reusable definition. Accordingly, the corresponding synchronization indicator may be received at block 856 before the reusable definition is modified. In other cases, the trigger definition GUI may indicate the workflows that utilize the reusable definition based on and/or in response to selection of the publish button and after receiving the modifications. Accordingly, the corresponding synchronization indicator may be received at block 856 after the reusable definition is modified but before the reusable definition is published.

The corresponding synchronization indicator received at block 856 may be used in combination with the synchronization indicator received at block 836 for the respective workflow. In some cases, the corresponding synchronization indicator received at block 856 may override the synchronization indicator received at block 836. As one example, workflows that are detached at block 856 might not be part of the workflows identified at arrow 854 by the trigger definition GUI as updated, and a corresponding synchronization indicator therefor might not be provided at block 856. As a second example, both the synchronization indicator received at block 836 and the synchronization indicator received at block 856 may indicate that the respective workflow is to remain synchronized with the reusable definition, and the modification obtained at block 856 may thus be used to update the respective workflow. As a third example, the synchronization indicator received at block 836 may indicate that the respective workflow is to remain synchronized with the reusable definition, but the synchronization indicator received at block 856 may indicate that the respective workflow is to be detached from the reusable definition, and the respective workflow might thus be detached from the reusable definition.

Based on and/or in response to obtaining the modification and/or the synchronization indicator at block 856, client device 614 may be configured to provide the modification and the synchronization indicator to trigger design application 610, as indicated by arrow 858. Based on and/or in response to reception of the modification and the synchronization indicator at arrow 858, trigger design application 610 may be configured to request storage of the reusable definition as modified in persistent storage 602, as indicated by arrow 860.

Based on and/or in response to reception of the request at arrow 860, persistent storage 602 may be configured to store the reusable definition in accordance with the synchronization indicator, as indicated by block 862. For example, when the synchronization indicator states that a given workflow is to be detached from the reusable trigger definition as modified, a copy of a prior version of the reusable definition may be added to the workflow before the prior version is overridden by the modifications.

### XI. Example Operations

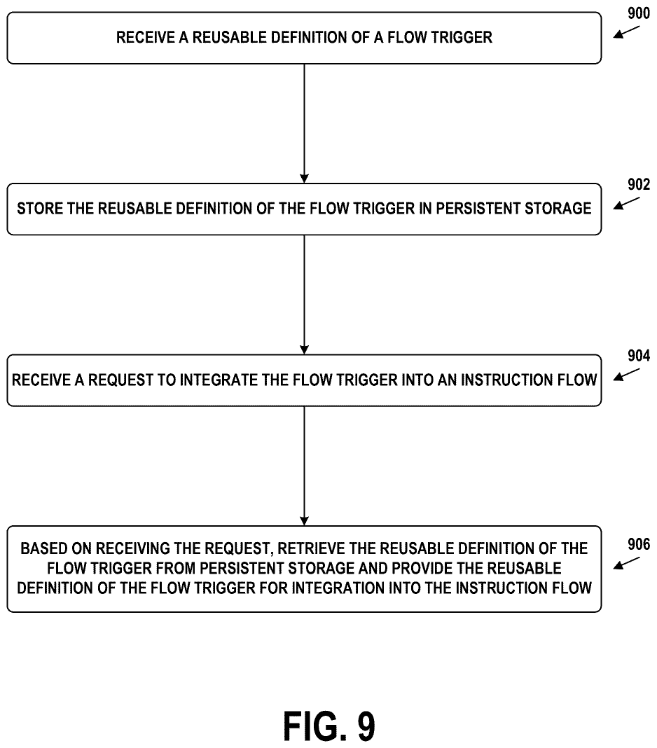

FIG. 9 is a flow chart illustrating an example embodiment. The process illustrated by FIG. 9 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 9 may be simplified by the removal of any one or more of the features shown therein. Further, these embodiments may be combined with features, aspects, and/or implementations of any of the previous figures or otherwise described herein.

Block 900 may involve receiving a reusable definition of a flow trigger. Defining the same or similar flow trigger anew multiple times as part of different instruction flows may increase the likelihood of introducing software errors into the instruction flows. Thus, specifying and reusing a single error-free definition of the flow trigger may reduce the amount of computing resources wasted on executing, identifying, and resolving the software errors across multiple instruction flows.

Block 902 may involve storing the reusable definition of the flow trigger in persistent storage. Storage of the reusable definition of the flow trigger may allow the reusable definition of the flow trigger to be integrated into a plurality of different instruction flows, thus allowing the flow trigger to be specified once and reused multiple times.

Block 904 may involve receiving a request to integrate the flow trigger into an instruction flow. Integrating an existing reusable definition of the flow trigger into the instruction flow may allow the largely duplicative process of manually specifying the flow trigger from scratch to be avoided, thereby reducing the amount of time and computing resources involved in specifying/defining a workflow.

Block 906 may involve, based on receiving the request, retrieving the reusable definition of the flow trigger from persistent storage and providing the reusable definition of the flow trigger for integration into the instruction flow.

In some examples, a representation of a user interface may be generated. The user interface may be configured to provide for definition of flow triggers. The reusable definition of the flow trigger may be received by way of the user interface.

In some examples, the reusable definition of the flow trigger may be flow-independent and may allow for integration of the flow trigger into a plurality of different instruction flows.

In some examples, receiving the reusable definition of the flow trigger may include receiving a plurality of incremental changes to a draft version of the reusable definition. After receiving the plurality of incremental changes, a request may be received to publish the reusable definition of the flow trigger to allow for integration of the flow trigger into instruction flows. The reusable definition may be stored based on receiving the request to publish the reusable definition. The reusable definition of the flow trigger may be available for integration into instruction flows when the reusable definition is stored in the persistent storage.

In some examples, the reusable definition of the flow trigger may include a flow trigger template populated by one or more values that specify a behavior of the flow trigger.

In some examples, when the flow trigger is integrated into the instruction flow, the flow trigger may be configured to trigger execution of one or more instructions in the instruction flow when a condition defined by the flow trigger is met.

In some examples, a representation of a user interface may be generated. The user interface may be configured to provide for definition of the instruction flow. The user interface may provide a graphical representation of the flow trigger. The request to integrate the flow trigger into the instruction flow may be based on a user interaction with the graphical representation of the flow trigger. The flow trigger may be integrated into the instruction flow by adding the reusable definition of the flow trigger to the instruction flow without modifying the reusable definition of the flow trigger.

In some examples, the user interface may allow the instruction flow to be defined using graphical representations of instruction flow components and without writing source code. A corresponding graphical representation of each respective instruction flow component of the instruction flow components may represent corresponding predefined source code.

In some examples, after integrating the flow trigger into the instruction flow, one or more additional trigger conditions may be received for the flow trigger and to be used as part of the instruction flow. The one or more additional trigger conditions may be added to the reusable definition of the flow trigger as integrated into the instruction flow and without modifying the reusable definition of the flow trigger as stored in the persistent storage.

In some examples, the request to integrate the flow trigger into the instruction flow may indicate that the instruction flow is to remain synchronized with the reusable definition of the flow trigger such that modifications made to the reusable definition of the flow trigger after integration of the flow trigger into the instruction flow are used to update the instruction flow to include the flow trigger as modified.

In some examples, the request to integrate the flow trigger into the instruction flow may indicate that the instruction flow is to be detached from the reusable definition of the flow trigger such that modifications made to the reusable definition of the flow trigger after integration of the flow trigger into the instruction flow do not affect the flow trigger as integrated into the instruction flow.

In some examples, a representation of a user interface may be generated. The user interface may be configured to provide for modification of the reusable definition of the flow trigger. The user interface may be configured to indicate one or more instruction flows that utilize and are synchronized with the flow trigger. A modification of the reusable definition of the flow trigger may be received. The modification may be provided by way of the user interface. Based on receiving the modification, the reusable definition as modified may be provided to the one or more instruction flows.

In some examples, a representation of a user interface may be generated. The user interface may be configured to provide for modification of the reusable definition of the flow trigger. A modification of the reusable definition of the flow trigger may be received by way of the user interface. For one or more instruction flows that utilize and are synchronized with the flow trigger, a synchronization indicator may be received that indicates whether to (i) keep the one or more instruction flows synchronized with the reusable definition as modified, (ii) detach the one or more instruction flows from the reusable definition as modified, or (iii) prompt a predetermined user for instructions on synchronizing the reusable definition as modified with the one or more instruction flows. The one or more instruction flows may be updated in accordance with the synchronization indicator and the reusable definition as modified.

In some examples, the request to integrate the flow trigger into the instruction flow may include receiving, at a plurality of different times, a plurality of requests to integrate the flow trigger into a plurality of different instruction flows. Based on receiving each respective request of the plurality of requests, the reusable definition of the flow trigger may be retrieved from persistent storage and provided for integration into a corresponding instruction flow of the plurality of different instruction flows.

In some examples, the reusable definition of the flow trigger may indicate whether one or more conditions that form part of the flow trigger are to be hidden from low-code users when the flow trigger is presented to the low-code users by way of a user interface used for defining the instruction flow.

In some examples, the reusable definition of the flow trigger may indicate whether the flow trigger is modifiable when the flow trigger is presented by way of a user interface used for defining the instruction flow.

In some examples, the instruction flow may be configured to be executed by a first computing system. The flow trigger may specify an event associated with a second computing system that is different from the first computing system.

In some examples, the first computing system may include one or more of a remote network management platform or a managed network. The second computing system may include a third-party computing system.

### XII. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A computer-implemented method comprising:
receiving a reusable definition of a flow trigger;
storing the reusable definition of the flow trigger in persistent storage;
receiving a request to integrate the flow trigger into an instruction flow; and
based on receiving the request, retrieving the reusable definition of the flow trigger from persistent storage and providing the reusable definition of the flow trigger for integration into the instruction flow.

2. The computer-implemented method of claim 1, further comprising:
generating a representation of a user interface configured to provide for definition of flow triggers, wherein the reusable definition of the flow trigger is received by way of the user interface.

3. The computer-implemented method of claim 1, wherein the reusable definition of the flow trigger is flow-independent and allows for integration of the flow trigger into a plurality of different instruction flows.

4. The computer-implemented method of claim 1, wherein:
receiving the reusable definition of the flow trigger comprises receiving a plurality of incremental changes to a draft version of the reusable definition,
the method further comprises, after receiving the plurality of incremental changes, receiving a request to publish the reusable definition of the flow trigger to allow for integration of the flow trigger into instruction flows,
the reusable definition is stored based on receiving the request to publish the reusable definition,
the reusable definition of the flow trigger is available for integration into instruction flows when the reusable definition is stored in the persistent storage.

5. The computer-implemented method of claim 1, wherein the reusable definition of the flow trigger comprises a flow trigger template populated by one or more values that specify a behavior of the flow trigger.

6. The computer-implemented method of claim 1, wherein, when the flow trigger is integrated into the instruction flow, the flow trigger is configured to trigger execution of one or more instructions in the instruction flow when a condition defined by the flow trigger is met.

7. The computer-implemented method of claim 1, further comprising:
generating a representation of a user interface configured to provide for definition of the instruction flow, wherein the user interface provides a graphical representation of the flow trigger, and wherein the request to integrate the flow trigger into the instruction flow is based on a user interaction with the graphical representation of the flow trigger; and
integrating the flow trigger into the instruction flow by adding the reusable definition of the flow trigger to the instruction flow without modifying the reusable definition of the flow trigger.

8. The computer-implemented method of claim 7, wherein the user interface allows the instruction flow to be defined using graphical representations of instruction flow components and without writing source code, and wherein a corresponding graphical representation of each respective instruction flow component of the instruction flow components represents corresponding predefined source code.

9. The computer-implemented method of claim 1, further comprising:
after integrating the flow trigger into the instruction flow, receiving one or more additional trigger conditions for the flow trigger to be used as part of the instruction flow; and
adding the one or more additional trigger conditions to the reusable definition of the flow trigger as integrated into the instruction flow and without modifying the reusable definition of the flow trigger as stored in the persistent storage.

10. The computer-implemented method of claim 1, wherein the request to integrate the flow trigger into the instruction flow indicates that the instruction flow is to remain synchronized with the reusable definition of the flow trigger such that modifications made to the reusable definition of the flow trigger after integration of the flow trigger into the instruction flow are used to update the instruction flow to include the flow trigger as modified.

11. The computer-implemented method of claim 1, wherein the request to integrate the flow trigger into the instruction flow indicates that the instruction flow is to be detached from the reusable definition of the flow trigger such that modifications made to the reusable definition of the flow trigger after integration of the flow trigger into the instruction flow do not affect the flow trigger as integrated into the instruction flow.

12. The computer-implemented method of claim 1, further comprising:
generating a representation of a user interface configured to provide for modification of the reusable definition of the flow trigger, wherein the user interface is configured to indicate one or more instruction flows that utilize and are synchronized with the flow trigger;
receiving a modification of the reusable definition of the flow trigger, wherein the modification is provided by way of the user interface; and
based on receiving the modification, providing the reusable definition as modified to the one or more instruction flows.

13. The computer-implemented method of claim 1, further comprising:
generating a representation of a user interface configured to provide for modification of the reusable definition of the flow trigger;
receiving a modification of the reusable definition of the flow trigger, wherein the modification is received by way of the user interface;
receiving, for one or more instruction flows that utilize and are synchronized with the flow trigger, a synchronization indicator that indicates whether to (i) keep the one or more instruction flows synchronized with the reusable definition as modified, (ii) detach the one or more instruction flows from the reusable definition as modified, or (iii) prompt a predetermined user for instructions on synchronizing the reusable definition as modified with the one or more instruction flows; and
updating the one or more instruction flows in accordance with the synchronization indicator and the reusable definition as modified.

14. The computer-implemented method of claim 1, wherein:
receiving the request to integrate the flow trigger into the instruction flow comprises receiving, at a plurality of different times, a plurality of requests to integrate the flow trigger into a plurality of different instruction flows, and
based on receiving each respective request of the plurality of requests, retrieving the reusable definition of the flow trigger from persistent storage and providing the reusable definition of the flow trigger for integration into a corresponding instruction flow of the plurality of different instruction flows.

15. The computer-implemented method of claim 1, wherein the reusable definition of the flow trigger indicates whether one or more conditions that form part of the flow trigger are to be hidden from low-code users when the flow trigger is presented to the low-code users by way of a user interface used for defining the instruction flow.

16. The computer-implemented method of claim 1, wherein the reusable definition of the flow trigger indicates whether the flow trigger is modifiable when the flow trigger is presented by way of a user interface used for defining the instruction flow.

17. The computer-implemented method of claim 1, wherein the instruction flow is configured to be executed by a first computing system, and wherein the flow trigger specifies an event associated with a second computing system that is different from the first computing system.

18. The computer-implemented method of claim 17, wherein the first computing system comprises one or more of a remote network management platform or a managed network, and wherein the second computing system comprises a third-party computing system.

19. A non-transitory computer-readable medium, having stored thereon program instructions that, upon execution by a computing system, cause the computing system to perform operations comprising:
receiving a reusable definition of a flow trigger;
storing the reusable definition of the flow trigger in persistent storage;
receiving a request to integrate the flow trigger into an instruction flow; and
based on receiving the request, retrieving the reusable definition of the flow trigger from persistent storage and providing the reusable definition of the flow trigger for integration into the instruction flow.

20. A system comprising:
one or more processors; and
memory, containing program instructions that, upon execution by the one or more processors, cause the system to perform operations comprising:
receiving a reusable definition of a flow trigger;
storing the reusable definition of the flow trigger in persistent storage;
receiving a request to integrate the flow trigger into an instruction flow; and
based on receiving the request, retrieving the reusable definition of the flow trigger from persistent storage and providing the reusable definition of the flow trigger for integration into the instruction flow.
